(19) United States
(12) Patent Application Publication
(10) Pub. No.: US 2015/0102694 A1
(43) Pub. Date: Apr. 16, 2015

(54) ROTOR STRUCTURE OF ELECTRIC MOTOR, AND METHOD FOR MANUFACTURING THE SAME

(71) Applicant: HYUNDAI MOBIS CO., LTD., Seoul (KR)

(72) Inventor: Jaehong Song, Yongin-si (KR)

(21) Appl. No.: 14/477,684

(22) Filed: Sep. 4, 2014

(30) Foreign Application Priority Data
Oct. 16, 2013 (KR) 10-2013-0123184

(51) Int. Cl. H02K 1/27; H02K 15/03; H02K 1/28

(52) U.S. Cl. CPC H02K 1/276; H02K 1/28; H02K 15/03
USPC 310/156.08; 29/598

(57) ABSTRACT

A rotor for preventing breakaway includes a shaft, a rotor core configured to be coupled to the shaft, and multiple permanent magnets configured to be inserted into the rotor core, wherein a cylindrical metallic ring is inserted and fixed on an outer surface of the rotor core.

### CROSS-REFERENCE TO RELATED APPLICATION

This application claims the benefit of priority to Korean Patent Application No. 10-2013-0123184, filed on Oct. 16, 2013, the entire contents of which are incorporated herein by reference.

### TECHNICAL FIELD

The present inventive concept relates to a motor for environmental vehicles; and, particularly, to a rotor for preventing breakaway which has a structure for preventing breakaway of a rotor magnet and/or a rotor core during a high-speed rotation.

In addition, exemplary embodiments of the present inventive concept relate to a motor having such a rotor for preventing breakaway.

In addition, exemplary embodiments of the present inventive concept relate to a method for manufacturing such a rotor for preventing breakaway.

### BACKGROUND

In general, an electric motor is constituted by an external stator and a rotor provided in the internal space of the stator, wherein, when a permanent magnet is included on the outside of the rotor, the rotor may be classified into a surface attachment type, an inner insertion type, and an integral type according to methods of including the permanent magnet.

In each of electric motors having various types of rotors as described above, the maximum number of rotation thereof is limited by the surface tension of a permanent magnet. In the order of the surface attachment type, the inner insertion type, and the integral type, a higher surface tension is shown, and accordingly, the maximum number of rotation increases.

### SUMMARY

An aspect of the present inventive concept relates to provide a rotor for preventing breakaway in which a rotor core and/or permanent magnets are prevented from breaking away from a rotor even when temperature increases, an electric motor having the same, and a method for manufacturing the same.

Another embodiment of the present inventive concept is directed to provide a rotor for preventing breakaway in which breakaway of a rotor core and/or permanent magnets are prevented due to weight reduction and centrifugal force reduction according to size reduction even when the rotation speed of a rotor increases, an electric motor having the same, and a method for manufacturing the same.

Other objects and advantages of the present inventive concept can be understood by the following description, and become apparent with reference to the embodiments of the present inventive concept. Also, it is obvious to those skilled in the art to which the present inventive concept pertains that the objects and advantages of the present inventive concept can be realized by the means as claimed and combinations thereof.

In order to achieve the aforementioned objects, a rotor for preventing breakaway in which a rotor core and/or permanent magnets are prevented from breaking away from a rotor even when temperature increases is provided.

In accordance with an embodiment of the present inventive concept, a rotor for preventing breakaway includes: a shaft; a rotor core configured to be coupled to the shaft; and multiple permanent magnets configured to be inserted into the rotor core, wherein a cylindrical metallic ring is inserted and fixed on an outer surface of the rotor core.

In this case, the metallic ring may be configured to be heat-treated in a range of 120° C. to 150° C.

In addition, the rotor core, the multiple permanent magnets, and the shaft may be configured to be cool-treated in a range of 20° C. to 30° C. below zero at a state in which the rotor core, the multiple permanent magnets, and the shaft have been assembled.

In addition, the metallic ring may be made of a stainless steel-based material, and a thickness of the metallic ring may be in a range of 1 to 10 mm.

In addition, the multiple permanent magnets may correspond to buried permanent magnets.

In accordance with another embodiment of the present inventive concept, a rotor for preventing breakaway includes: a shaft; a rotor core configured to be coupled to the shaft; multiple permanent magnets configured to be inserted into the rotor core, and a string-shaped composite-material protection tube configured to surround an outer surface of the rotor core, wherein multiple wires are configured to pass through the shaft, the rotor core, and the multiple permanent magnets, and to be integrally fixed from an outer surface of the shaft to the outer surface of the rotor core.

In this case, the multiple wires may be configured to have a thickness within a range of 1 to 2 mm.

In accordance with still another embodiment of the present inventive concept, a rotor for preventing breakaway includes: a shaft; a rotor core configured to be coupled to the shaft; multiple permanent magnets configured to be inserted into the rotor core, and a string-shaped composite-material protection tube configured to surround an outer surface of the rotor core, wherein multiple shaft-direction reinforcing members are configured to be wound on an outer surface of the composite-material protection tube at a predetermined interval.

In addition, the rotor may additionally include a bolting part configured and provided to pass through the rotor core.

In accordance with still another embodiment of the present inventive concept, an electric motor includes: the rotor for preventing breakaway described above; and a stator configured to contain the rotor inserted therein.

In accordance with still another embodiment of the present inventive concept, a method for manufacturing a rotor includes: heat-treating a metallic ring; cool-treating a rotor core, multiple permanent magnets, and a shaft in a state in which the rotor core, the multiple permanent magnets, and the shaft, except for the metallic ring, have been assembled; inserting the metallic ring being heat-treated into the rotator; and cooling the rotor with the metallic ring inserted therein during a predetermined period of time.

In this case, heat treatment temperature of the metallic ring may be in a range of 120° C. to 150° C.

In addition, temperature for the cool treatment may be in a range of 20° C. to 30° C. below zero.

### BRIEF DESCRIPTION OF THE DRAWINGS

FIG. 1 is a conceptual view illustrating a general breakaway prevention structure to which a fiber-reinforced composite material is applied;

FIG. 2 is a conceptual view illustrating the shape of a protection tube of a composite material illustrated in FIG. 1;

FIG. 3 is a view illustrating the shape of a cylindrical metallic ring in accordance with an embodiment of the present inventive concept;

FIG. 4 is a conceptual view showing a case where a rotor core, a permanent magnet, and a shaft are integrally fixed to a cylindrical metallic ring using thin wires in accordance with an embodiment of the present inventive concept;

FIG. 5 is a conceptual view illustrating a case where a shaft-direction reinforcing member is inserted into and is fixed to a cylindrical metallic ring in accordance with an embodiment of the present inventive concept; and

FIG. 6 is a flowchart showing a procedure of assembling and manufacturing a metallic ring with respect to a rotor in accordance with an embodiment of the present inventive concept.

### DETAILED DESCRIPTION

As the present inventive concept may make various changes and have various forms, it is intended to illustrate specific embodiments in the drawings and describe them in detail. However, it should be understood that this is intended not to limit the present inventive concept to specific disclosed forms but to include all changes, equivalents and replacements that fall within the spirit and technical scope of the present inventive concept. Like reference signs are used for like components in describing each drawing.

Like reference signs are used for like components in describing each drawing.

Although the terms like a first and a second are used to describe various components, the components should not be limited by the terms. The terms may be used for the purpose of distinguishing one component from another.

For example, a first component may be named a second component and similarly, a second component may be named a first component without departing from the scope of right of the present inventive concept. The term and/or includes a combination of a plurality of related described items or any of the plurality of related described items.

Unless being otherwise defined, all terms used herein that include technical or scientific terms have the same meaning as those generally understood by those skilled in the art.

The terms, such as those defined in dictionaries generally used should be construed to have meaning matching that having in context of the related art and are not construed as ideal or excessively perfunctory meaning unless being clearly defined in this application.

In medium and large-sized motors, in the case where a remaining type of rotor, except for the integral type of rotor, is used, as the number of rotation increases while the surface tension of a permanent magnet is constant, the centrifugal force continuously increases.

At a rotation speed, or more, which causes the increasing centrifugal force to exceed the surface tension, the permanent magnet may break away to the outside.

In order to solve such a breakaway problem, a method of increasing the thickness of a bridge of a rotor core, a method of using fiber-reinforced composite material, and the like have been proposed.

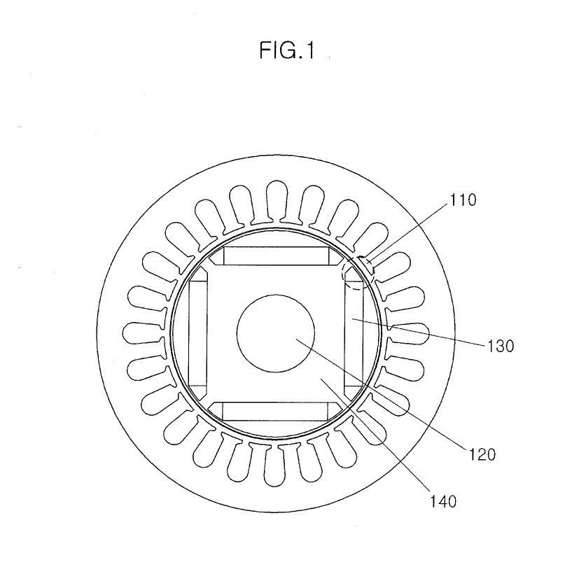

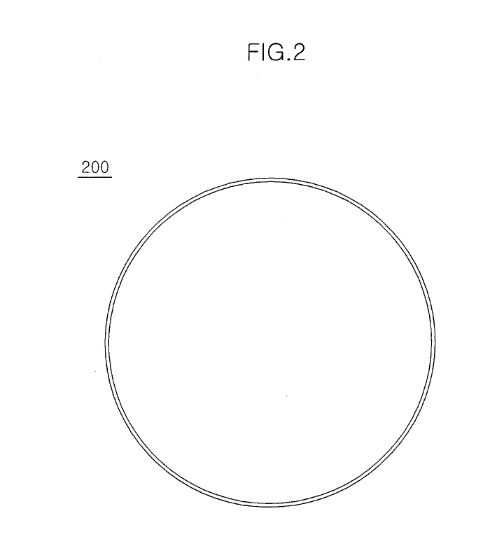

According to one embodiment, the method of using fiber-reinforced composite material is illustrated in FIGS. 1 and 2. Referring to FIGS. 1 and 2, a scheme of winding about a rotor core 140 in the shape of a string is shown. That is to say, a protection tube of a composite material which is wound in the shape of a string about the outside of the rotor core 140 coupled to a shaft 120 is used to prevent breakaway from occurring. The shape of such a protection tube 200 of a composite material is illustrated in FIG. 2. A permanent magnet 130 is mounted on the rotor core 140, and the thickness of a composite material, as shown in a circle 110 in FIG. 1, is approximately 0.5 mm in the shape thereof.

However, such a rotor breakaway prevention structure has a limit due to the temperature (generally, 150° C.) of the composite material.

In addition, since the composite material must be wound in the shape of a string, the process for mass production is complicated, and a long period of time is required for production.

In addition, as an environmental vehicle travels at a higher speed, the rotor thereof rotates at a higher speed, which increases the centrifugal force of the rotor and thus increases the breakaway probability of the rotor. Accordingly, the environmental vehicle has a limit in increasing the speed thereof.

Hereinafter, a rotor for preventing breakaway and an electric motor having the same according to an embodiment of the present inventive concept will be described in detail below with reference to the accompanying drawings.

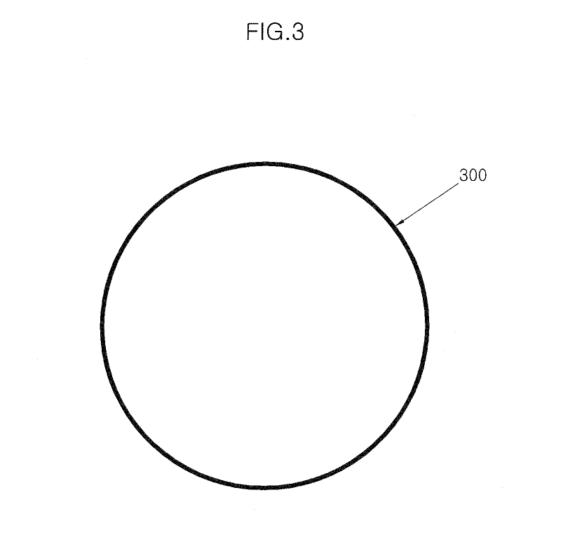

FIG. 3 is a view illustrating the shape of a cylindrical metallic ring in accordance with an embodiment of the present inventive concept. Referring to FIG. 3, a structure in which a cylindrical metallic ring 300 is pre-manufactured and inserted onto the outer surface of a rotor core is shown. Before the metallic ring 300 is assembled on the outer surface of the rotor, the metallic ring 300 is heat-treated in a range of 120° C. to 150° C.

In addition, the metallic ring 300 is made of a stainless steel-based material or nickel-chrome based alloy, for example, SUS 304, Inconel 718, or the like. SUS 304 has the maximum yield strength of 210 MPa, and Inconel 718 has the maximum yield strength of 1.1 GPa. That is to say, in order to increase a speed even with the thickness of a core bridge equally-maintained or reduced, a steel-based ring for preventing breakaway is assembled and used.

In addition, the thickness of the metallic ring 300 is in a range of approximately 1 to 10 mm, and is different depending on the external diameter and model of a rotor core.

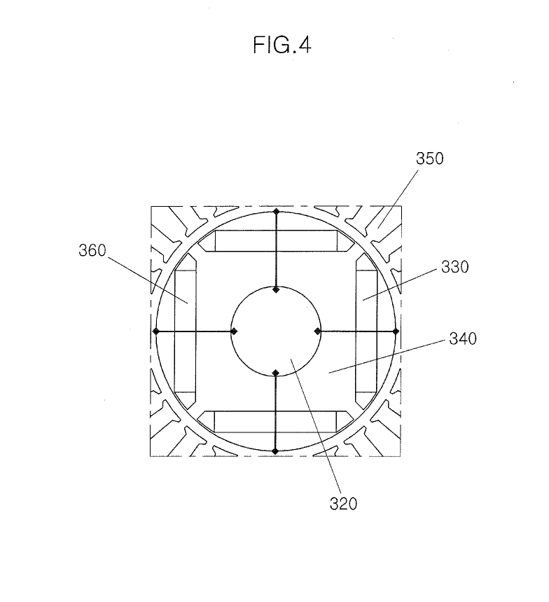

FIG. 4 is a conceptual view showing a case where a rotor core, a permanent magnet, and a shaft are integrally fixed to a breakaway prevention structure of a composite-material protection tube, which is wound in the shape of a string, using thin wires in accordance with an embodiment of the present inventive concept. Referring to FIG. 4, wires 360 pass through a shaft 320, a rotor core 340 coupled to the shaft 320, and multiple permanent magnets 330 inserted into the rotor core 340, and are integrally fixed from the outer surface of the shaft 320 to the outer surface of the rotor core 340.

It goes without saying that, as described above, the outer surface of the rotor core 340 is surrounded by a protection tube of a composite material.

The wires 360 are configured to have a thickness of approximately 1 mm to 2 mm. Although FIG. 4 shows a case where four wires 360 are mounted and assembled at 90 degree intervals, the shape and number of fixed wires may vary depending on the number of poles of a magnet. That is to say, multiple points may be applied in a shaft direction.

In addition, the multiple permanent magnets 330 are configured with buried permanent magnets.

The rotor is inserted into a stator 350.

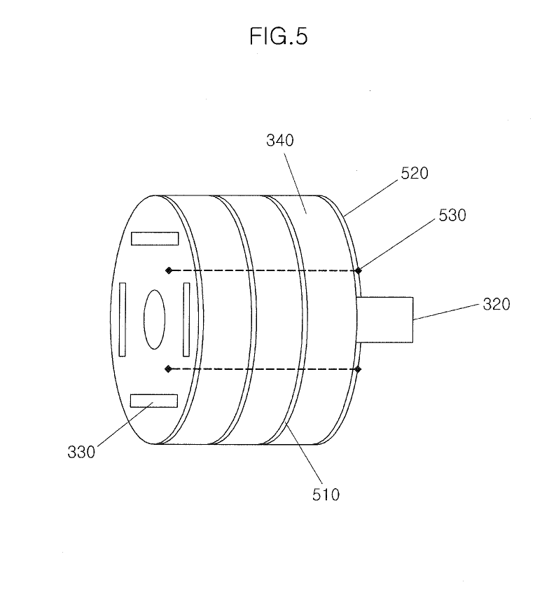

FIG. 5 is a conceptual view illustrating a case where a shaft-direction reinforcing member is inserted into and is fixed to a breakaway prevention structure of a composite-material protection tube, which is wound in the shape of a string, in accordance with an embodiment of the present inventive concept. Referring to FIG. 5, a rotor is constituted by a rotor core 340 configured with multiple stacked steel plates, multiple permanent magnets 330 inserted into the rotor core 340, end plates 520 assembled on both ends of the rotor core 340, and the like.

In this case, two shaft-direction reinforcing members 510 are configured to surround the outer surface of the rotor core 340 at a predetermined interval.

In this case, also, it goes without saying that a protection tube of a composite material is wound on the outer surface of the rotor core 340.

In addition, a bolting part 530 passing through the rotor core 340 is additionally mounted.

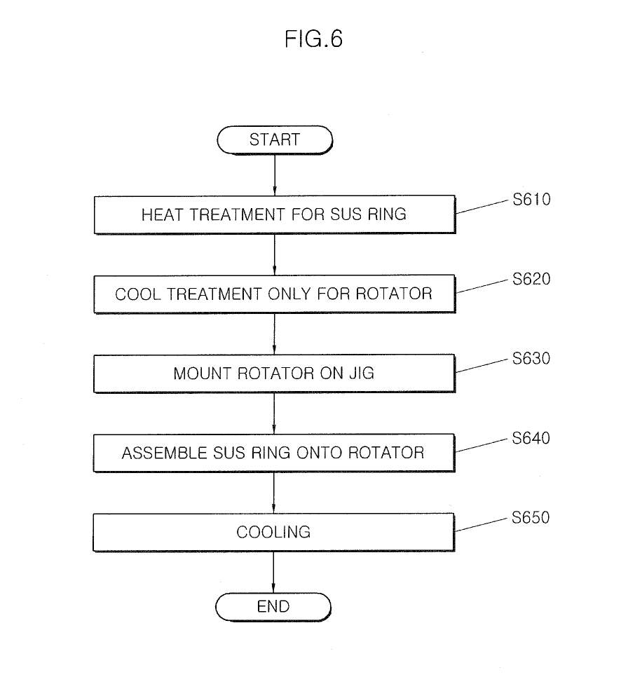

FIG. 6 is a flowchart showing a procedure of assembling and manufacturing a metallic ring with respect to a rotor in accordance with an embodiment of the present inventive concept. Referring to FIG. 6, a metallic ring 300 is heat-treated in a range of approximately 120° C. to 150° C. in step S610.

A rotor not including the metallic ring 300 (e.g. at a state in which a rotor core, a permanent magnet, and a shaft have been assembled) is put into an icebox for test, and then the rotor (including the rotor core, the permanent magnet, and the shaft) is cool-treated in a range of 20-30° C. below zero in step S620.

The rotor (including the rotor core, the permanent magnet, and the shaft) is mounted on a jig (not shown) to stand up, and then the heat-treated metallic ring 300 is assembled and coupled to the rotor using a sliding jig (not shown) in steps S630 and S640.

When a predetermined period of time has elapsed, the heat-treated metallic ring 300 is expansion-fitted in the rotor in a tight fit manner while being cooled in step S650.

Since the metallic ring 300 is tightly fixed on the outer surface of the rotor core, the speed can increase without breakaway of the rotor core and permanent magnets even at a high-speed rotation.

In accordance with the exemplary embodiments of the present inventive concept, since a cylindrical metallic ring is applied, the influence by temperature is very small although the temperature increases, and thus the speed and the output power can be enhanced.

In addition, in accordance with the exemplary embodiments of the present inventive concept, since a cylindrical metallic ring is applied, the thickness of a core bridge is equally maintained or reduced, and such a size reduction results in weight reduction to reduce the centrifugal force, thereby lowering the probability of breakaway of the rotor core and/or the permanent magnets even at a high speed.

In addition, in accordance with the exemplary embodiments of the present inventive concept, since a cylindrical metallic ring is applied, assembling and manufacturing can be easily achieved.

While the present inventive concept has been described with respect to the specific embodiments, it will be apparent to those skilled in the art that various changes and modifications may be made without departing from the spirit and scope of the invention as defined in the following claims.

What is claimed is:

1. A rotor of an electric motor, the rotor comprising:
a shaft;
a rotor core configured to be coupled to the shaft and comprising cavities;
permanent magnets received in the cavities of the rotor core; and
a cylindrical metallic ring surrounding the rotor core and fixed to an outer surface of the rotor core.

2. The rotor of claim 1, wherein the metallic ring is configured to be heat-treated in a range of 120° C. to 150° C.

3. The rotor of claim 1, wherein the rotor core, the permanent magnets, and the shaft are configured to be cool-treated in a range of 20° C. to 30° C. below zero at a state in which the rotor core, the permanent magnets, and the shaft have been assembled.

4. The rotor of claim 1, wherein the metallic ring is made of a stainless steel-based material or a nickel-chrome based alloy, and a thickness of the metallic ring is in a range of 1 mm to 10 mm.

5. The rotor of claim 1, wherein the permanent magnets are embedded in the magnetic core.

6. A rotor for preventing breakaway, comprising:
a shaft;
a rotor core configured to be coupled to the shaft and comprising cavities;
permanent magnets received in the cavities of the rotor core; and
a string-shaped composite-material protection tube surrounding the rotor core.

7. The rotor of claim 6, wherein a wire extends from the shaft, and through the rotor core, and at least one of the permanent magnets, and comprises one end fixed to the shaft and the other end fixed to the outer surface of the rotor core.

8. The rotor of claim 6, wherein the wire has a thickness within a range of 1 mm to 2 mm.

9. The rotor of claim 6, wherein a reinforcing member extending along a direction parallel to the shaft and is fixed to the magnetic core and placed over an outer surface of the composite-material protection tube at a predetermined interval.

10. The rotor of claim 9, further comprising a bolt extending through the rotor core.

11. A method for manufacturing a rotor, comprising:
heat-treating a metallic ring;
cool-treating an assembly of a rotor core, multiple permanent magnets, and a shaft in a state in which the rotor core, the multiple permanent magnets, and the shaft, except for the metallic ring, have been assembled;
inserting the assembly into the metallic ring which is being heat-treated; and
cooling the assembly with the metallic ring for a predetermined period of time.

12. The method of claim 11, wherein heat treatment temperature of the metallic ring is in a range of 120° C. to 150° C.

13. The method of claim 11, wherein temperature for the cool treatment is in a range of 20° C. to 30° C. below zero.

14. The method of claim 11, wherein the metallic ring is made of a stainless steel-based material or a nickel-chrome based alloy.
